(19) United States
(12) Patent Application Publication
(10) Pub. No.: US 2018/0215501 A1
(43) Pub. Date: Aug. 2, 2018

(54) Battery Package For Sale And Recycling

(71) Applicant: Moshe Begim, East Rancho Dominguez, CA (US)

(72) Inventor: Moshe Begim, East Rancho Dominguez, CA (US)

(21) Appl. No.: 15/937,376

(22) Filed: Mar. 27, 2018

Related U.S. Application Data
(63) Continuation-in-part of application No. 15/724,244, filed on Oct. 3, 2017.
(60) Provisional application No. 62/403,581, filed on Oct. 3, 2016.

(51) Int. Cl. B65D 5/496; B65D 85/68; B65D 5/42; B65D 75/36; H01M 6/52

(52) U.S. Cl. CPC B65D 5/4804; B65D 85/68; B65D 5/4204; B65D 2585/88; B65D 75/367; H01M 6/52; B65D 5/4208

(57) ABSTRACT

A box for both selling batteries and recycling them after use includes a top flap and a bottom flap with windows spanning the box from between them. The windows are evenly spaced across the box and sized to show individual batteries inside the box while preventing the batteries from exiting the box through the windows. A divider is also located in the box. The divider is configured to cradle one of the batteries and obscure one of the windows. The box preserves the batteries in a row, such that when one of the batteries is removed from the first bottom flap, the divider and the remaining batteries slide down away from the top flap and toward the first bottom flap. When the last battery is removed, used, and placed back in the box, all of the batteries can be recycled using the box as a holder.

### RELATED APPLICATIONS

This application is a continuation of U.S. application Ser. No. 15/724,424 filed on Oct. 3, 2017. The Ser. No. 15/724,424 application claims the benefit of the priority filing date of U.S. provisional patent application Ser. No. 62/403581, filed on Oct. 3, 2016, which is incorporated by reference in its entirety.

### BACKGROUND

Many consumer products, from toys to remote controllers to cordless electronics, are powered by replaceable battery cells. The most common of these retail consumer batteries are manufactured according to standardized sizes, such as cylindrical AAA, AA, or C cells, or non-cylindrical varieties such as 9-volt cells, among others. Consumer batteries are classified as either primary, non-rechargeable batteries, intended for disposal after use, or less common secondary, rechargeable batteries which may be removed when discharged, plugged into a recharging apparatus and reused when recharged.

Both primary and secondary batteries are made from various materials having some level of toxicity. Secondary batteries are typically made from nickel (nickel oxyhydroxide) combined with either metallic cadmium (i.e., NiCd batteries) or a hydrogen-absorbing metal alloy (i.e., nickel-metal hydride batteries). Primary batteries, such as most common alkaline batteries, typically use zinc and manganese dioxide.

Secondary, rechargeable batteries are beneficial in that they are reusable and avoid the problems associated with disposing toxic materials, but they remain disfavored due to their generally lower capacity and higher cost. Primary batteries are favored due to their higher capacity and lower cost, but their disposal results in large quantities of toxic material entering the environment, including an ongoing risk of leakage after disposal due to lingering and continuing self-discharge. For example, primary alkaline batteries are prone to leak potassium hydroxide, a caustic agent that can cause respiratory, eye and skin irritation. For this reason, among others, battery recycling regimes have been created for returning spent primary cells.

Although municipal and private battery recycling centers exist, consumers are generally unwilling to recycle spent primary batteries due to the inconvenience and expense of storing quantities of used batteries, and traveling sometimes great distances to recycling facilities. For this reason, systems have been created for shipping spent primary cells to recycling facilities. One such system involves ordering disassembled containers which may be filled with used batteries and shipped to recycling facilities. Although this process avoids the need for traveling to a recycling facility, it is cost prohibitive since consumers must pay for the materials and service, and expend time and effort in ordering a container, assembling the container, and shipping the container back to a recycle facility.

Another recycling process involves selling charged primary consumer batteries in a plastic package that can be re-used for shipping the batteries to a recycling facility when discharged. Although this process avoids the need for consumers to special order a package to hold discharged batteries, considerable time, effort and expense is still required to transport the package filled with discharged batteries to a postal facility for mailing. Also, these packages are typically non-recyclable and thus create their own waste disposal problems.

Stores selling consumer batteries should be willing to accept discharged primary cells on site as an incentive to encourage recycling. Offering to recycle the batteries they sell will demonstrate that companies are good environmental citizens and promote customer brand loyalty. Another advantage is accepting discharged batteries at the point of purchase for recycling, particularly when a rebate or similar inducement is offered, will draw customers back into a store where they will not only buy new batteries but may also purchase additional goods.

Thus it is an object of the present invention to provide a consumer battery primary cell recycling system that avoids the time and expense of consumers having to order special transport containers. Another object of the invention is to provide a recycling system that avoids the time and expense of consumers having to ship discharged batteries to a special recycling location through the postal or similar delivery service. Another object of the invention is to provide a recycling system that avoids the need for additional travel to a recycling center separate from the store where batteries are purchased. Another object of the invention is to provide a system allowing consumers to easily keep track of and store charged and discharged batteries, and which allows both the batteries and their packaging to be easily recycled.

### SUMMARY

A box for retailing batteries and then recycling the batteries after use and discharge includes in one embodiment a top flap and a first bottom flap. A plurality of windows substantially span the box from a position near the top flap to a position near the first bottom flap. The windows are preferably evenly spaced across the box and are sized to individually reveal the batteries inside the box while preventing the batteries from exiting the box through the windows. A divider is located in the box, and the divider is configured to cradle one of the batteries, while also being configured to obscure one of the windows. The box is sized so that it preserves the batteries aligned in a column, such that when one of the batteries is removed from the first bottom flap, the divider and the remaining batteries slide or otherwise move away from the top flap and toward the first bottom flap.

In various alternative embodiments, the box includes a second bottom flap, and the second bottom flap preferably opposes the first bottom flap. The first bottom flap and the second bottom flap are configured such that pressing the first bottom flap urges one of the batteries out of the second bottom flap. The windows are preferably disposed on a front panel of the box, and in one embodiment are disposed in a column on the front panel of the box. The divider may be formed as a u-shaped channel, and preferably spans the front panel of the box. The box may also include a handle portion extending above the batteries for suspending and displaying the box. The top flap is preferably disposed adjacent a handle portion extending above the batteries to provide maximum storage.

In an alternative embodiment, the box for retailing and recycling batteries includes a box portion and a handle portion extending above the box portion. The box portion has a top flap adjacent the handle portion, and a series of windows are disposed on a front panel of the box portion, and are configured to display each of the batteries. The front panel preferably spans a first side panel and a second side panel, with the first side panel and the second side panel each substantially the width of each of the batteries. A first bottom flap is formed in the first side panel and a second bottom flap is formed in the second side panel. A divider is located in the box portion, and is configured to cradle one of the batteries and one of the windows. When one of the batteries is removed from the box portion, the divider and the remaining batteries slide down toward the first bottom flap.

Preferably, the first bottom flap and the second bottom flap are configured such that pressing the first bottom flap urges one of the batteries out of the second bottom flap. The windows are preferably disposed in a column on the front panel of the box. The divider preferably comprises a u-shaped channel, and substantially spans the front panel. Preferably, the box portion and the handle portion are formed from a unitary cardboard blank.

A method is also disclosed for forming a box for recycling batteries. The method includes the steps of, forming a box portion having a first bottom flap, a second bottom flap and a top flap. A handle portion is formed extending from the box portion and is formed adjacent the top flap. A series of windows are formed in the box portion. A divider is provided, configured to cradle one of the batteries, and further configuring the divider to obscure one of the windows. Batteries are inserted into the box portion, and the divider is inserted into the box portion prior to sealing the box portion for sale.

In various embodiments, the method may include forming the handle portion by sealing a handle flap to a rear panel of the box portion. Additionally, the divider may be folded into a u-shaped piece spanning the box portion, and the divider may be placed under one of the batteries, in one alternative embodiment, the box portion and the handle portion are both formed from a unitary cardboard blank.

### BRIEF DESCRIPTION OF THE FIGURES

FIG. 1 illustrates a perspective view of a battery package for sale and recycling filled with charged batteries displayed for sale;

FIG. 2 illustrates a perspective view of a user removing a charged battery from the battery package;

FIG. 3 illustrates a perspective view of a user inserting a discharged battery into the battery package;

FIG. 4 illustrates a section view of the battery package holding charged batteries and discharged batteries, separated by a divider;

FIG. 5 illustrates a flat pattern blank for folding into the battery package;

FIG. 6 illustrates the flat pattern blank in a first stage of folding;

FIG. 7 illustrates the flat pattern blank in a second stage of folding;

FIG. 8 illustrates the battery package with the top open and a battery ready for insertion followed by the divider.

FIG. 9 illustrates a front perspective view of an alternative embodiment of the battery package for sale and recycling filled with charged batteries; and

FIG. 10 illustrates a rear perspective view of the alternative embodiment of the battery package for sale and recycling filled with charged batteries.

### DETAILED DESCRIPTION

The following description is presented to enable any person skilled in the art to make and use the invention, and is provided n the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

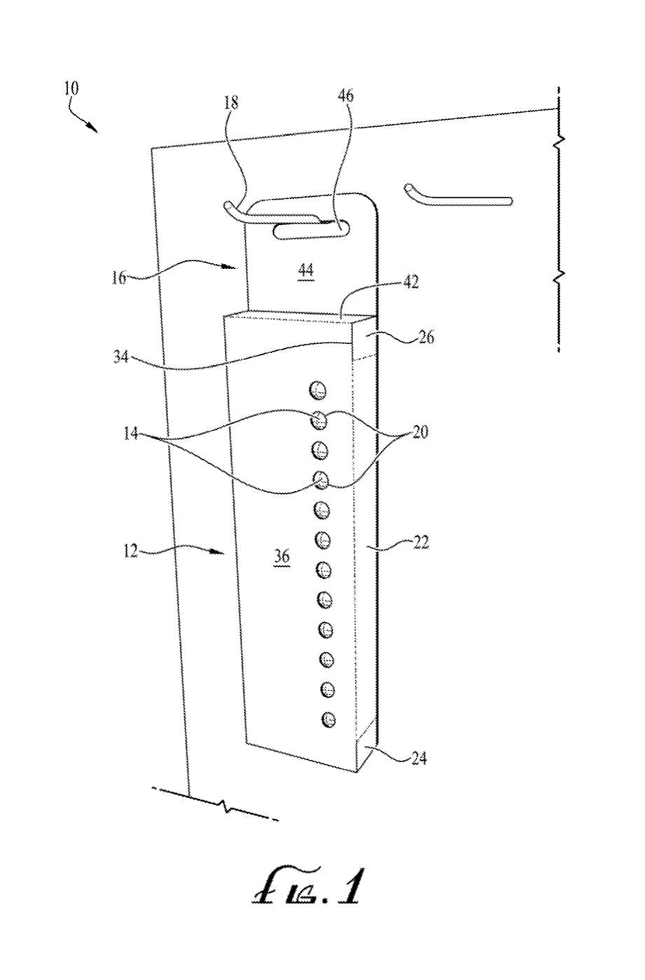

Referring to FIG. 1, the battery package for sale and recycling (package) 10 includes a box portion 12 for containing batteries 14 and a handle portion 16 for effective storage and attractive display. The package 10 is similar to a conventional battery packages in that it hangs from a peg 18 for easy selection and removal by a user, and includes a series of windows 20 allowing the user to see the batteries. Preferably the windows 20 are sized so they resist tampering and are difficult to rip open to access the batteries 14, approximately a diameter of 5 mm or 0.25 inches.

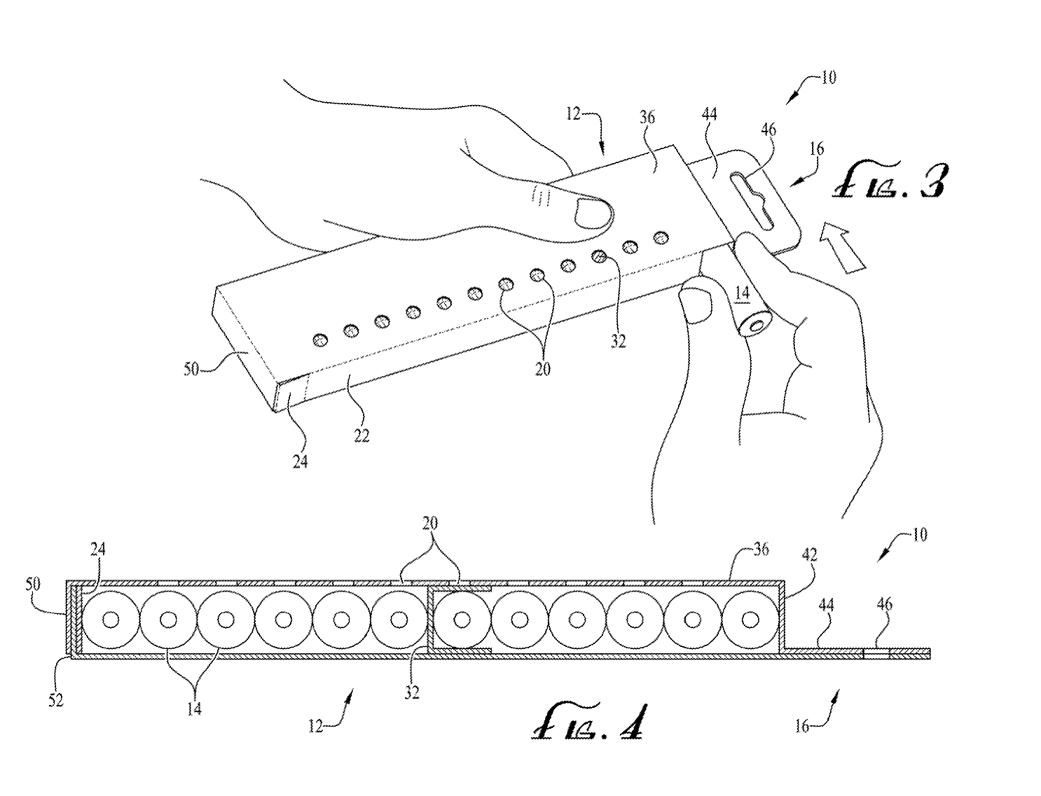

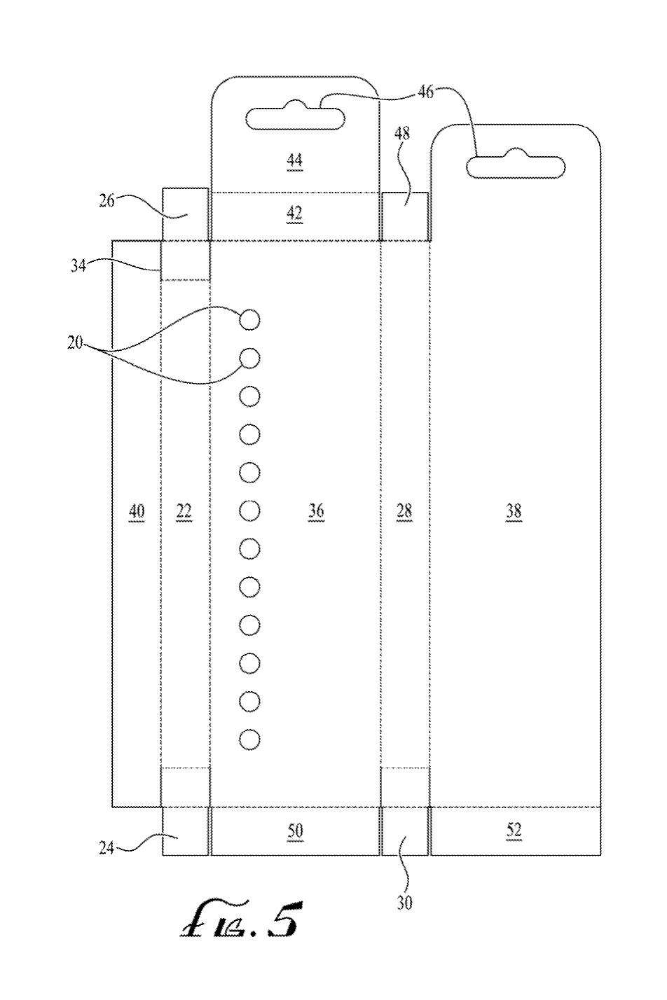

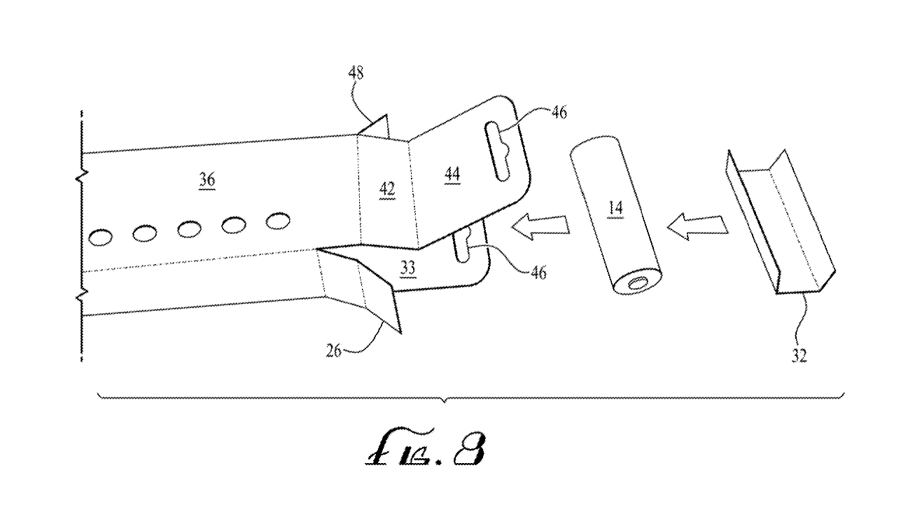

Unlike conventional containers, the package 10 also includes a first side 22 having a first bottom flap 24 and a first top flap 26, and a second side 28 (FIGS. 5-7), having a second bottom flap 30 (FIGS. 5-7). The first bottom flap 24 and the second bottom flap 32 open for removing a new, charged battery 14, and the first top flap 26 opens to allow the user to insert the battery 14 after discharge. A divider 32 (FIGS. 3-4) is located inside the package 10 adjacent the first top flap 26.

The first bottom flap 22, first top flap 26, and second bottom flap 30 are preferably sealed prior to purchase with breakable seals 34, such as a perforation for example. Once the user purchases the package 10, the breakable seals 34 may be ruptured by finger pressure. When the user presses against the first bottom flap 24 or the second bottom flap 30, a battery 14 inside the package 10 ruptures the corresponding first bottom flap 24 or second bottom flap 30.

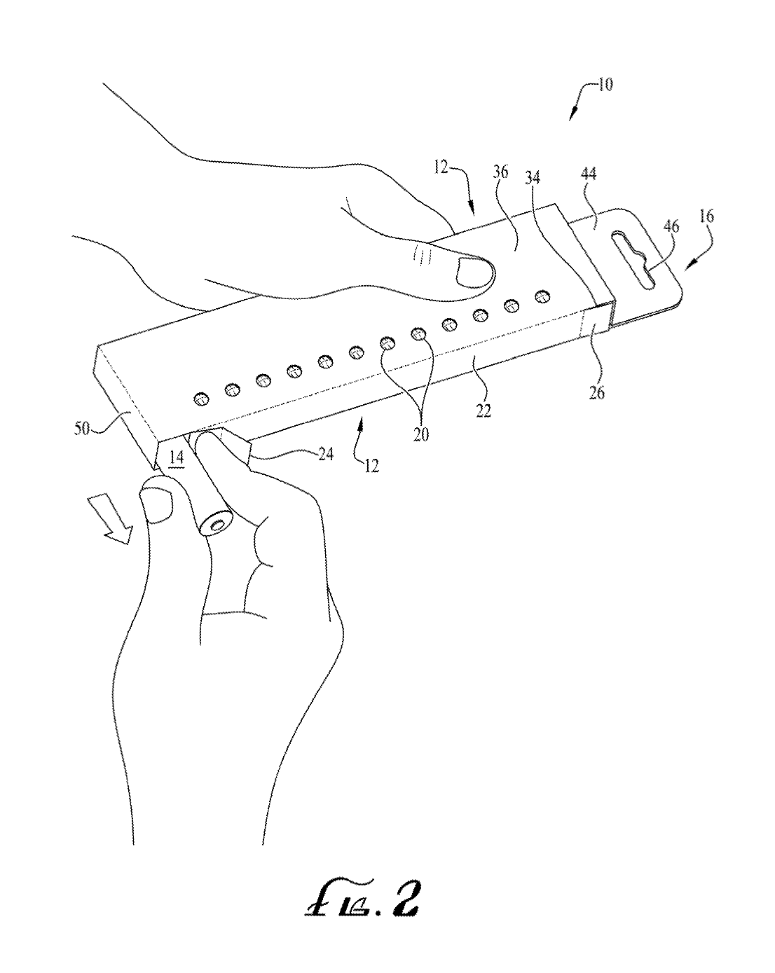

Referring to FIG. 2, when a user presses against, for example, the first bottom flap 24, the battery 14 emerges from the second bottom flap 30. Preferably this action may also be performed in reverse for removing the battery 14. When the battery 14 is removed, the remaining batteries 14 in the package 10 travel down under gravity to adjoin the fist bottom flap 24 and second bottom flap 30. Additional batteries 14 may be removed from the package 10 by repeating the action, installed into a battery powered consumer product and used as desired.

Referring to FIG. 3, once the batteries 14 are discharged, the user presses, either with a finger or with the discharged battery 14 against the first top flap 26 to break the breakable seal 34. The discharged battery 14 may then be inserted through the first top flap 26 into the package 10. The first discharged battery 14 entering the package 10 encounters the divider 32. When the battery 14 is fully inserted into the package 10, it moves down under gravity, pressing the divider 32 down to appear in the uppermost window 20 near the handle portion 16 of the package 10.

The divider 32 is preferably at least U-shaped to completely obscure a window 20, and may enclose the battery 14 on all sides except from above. Preferably, windows 20 are spaced evenly on the package 10 to show each battery 14 when the package 10 is first purchased. The divider 32 is installed adjacent the first top flap 26. When a discharged battery 14 is initially inserted into the first top flap 26, it comes to rest on the divider 32 inside the package 10, gravity causes the battery 14 and divider 32 to move downward. Since the windows 20 are evenly spaced according to battery 14 size, the divider 32 appears in a window 20. The divider 32 may be brightly colored for ease of visibility.

Referring to FIG. 4, as charged batteries 14 are removed from the package 10 and additional discharged batteries 14 are inserted into the package 10, they move down under gravity, causing the divider 32 to move down from window 20 to window 20 toward the first bottom flap 24 and second bottom flap 30. When the divider 32 reaches the window 20 at the level of first bottom flap 24 and second bottom flap 30, it indicates that the package 10 is now filled with discharged batteries 14. The package 10 can then be easily and conveniently taken back to the point of purchase and delivered for recycling and a fresh package 10 of new, charged batteries 14 purchased. In addition to recycling the batteries 14, the package 10 and divider 32 are preferably made of paperboard, cardboard or a similarly recyclable material, enabling both the batteries 14 and the package 10 to be recycled.

Referring to FIG. 5, the package 10 is preferably formed from a single foldable blank of recyclable material such as paperboard. The box portion 12 is formed, in addition to the first side 22 and the second side 28 by a window 20 bearing front panel 36 and a rear panel 38, all coupled together using a side tab 40. The rear panel 38 extends to form part of the handle portion 16 of the package 10. The front panel 36 includes a second top flap 42. A handle flap 44 extends from the second top flap 42. Preferably matching peg holes 46 are included in the rear panel 38 and the handle flap 44 for hanging the package 10. A third top flap 48 extends from the second side 28. In addition to the first bottom flap 24 and the second bottom flap 30, a third bottom flap 50 and a fourth bottom flap 52 extend from the front panel 36 and rear panel 38, respectively. The first bottom flap 24, second bottom flap 30 and first top flap 26 preferably incorporate folds for insertion into the box portion 12 of the package 10.

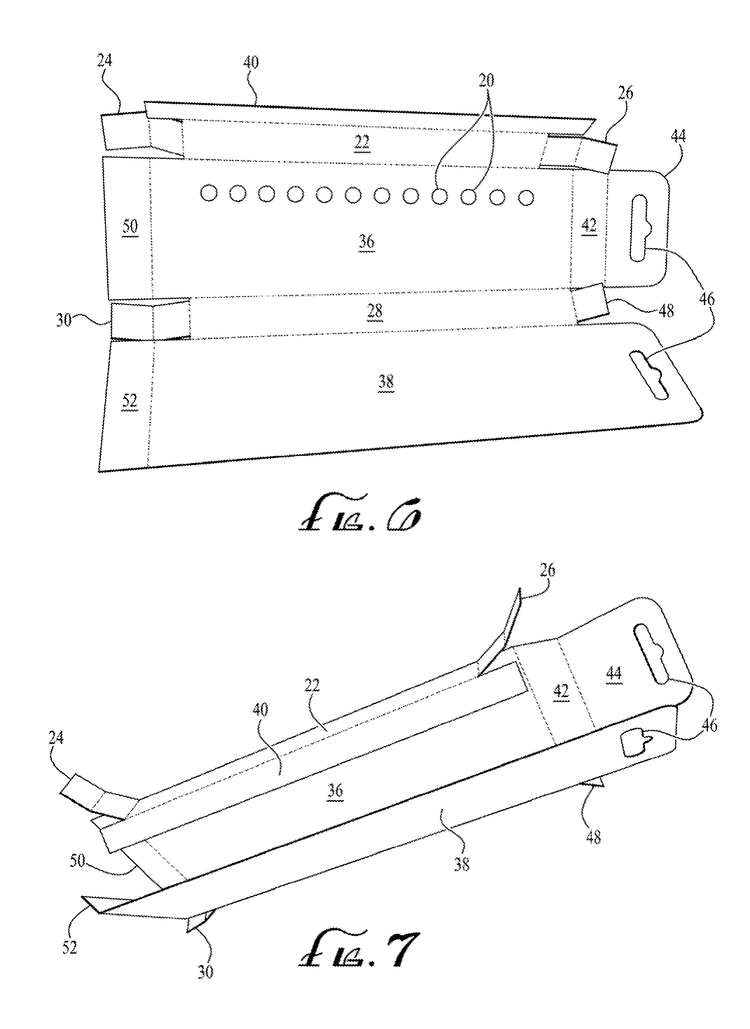

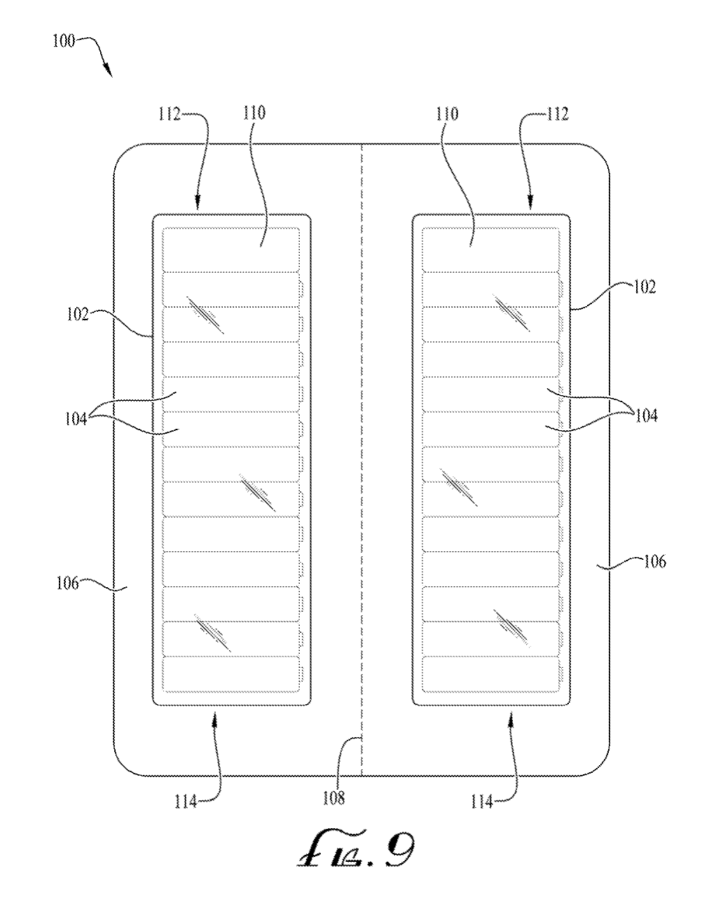

Referring to FIGS. 6-8, the box portion 12 is formed by folding the rear panel 38 over the front panel 36 and coupling the side tab 40 to the rear panel 38. This results in an open ended box portion 12. Thereafter, the box portion 12 can be sealed opposite the handle portion 16 by coupling and sealing together the third bottom flap 50 and the fourth bottom flap 52 over the first bottom flap 24 and second bottom flap 32. A series of new, charged batteries 14 may then be introduced into the box portion 12 of the package 10. Once the batteries 14 have been introduced, the divider is installed adjacent the handle portion 16.

To seal the box portion 12, the first top flap 26 and the third top flap 48 are folded under the second top flap 42, and the handle flap 44 is folded against, coupled and sealed to the rear panel 38 so that the peg holes 46 are overlapping. Once the box portion 12 is sealed, each new, charged battery 14 appears in a window 20, and the divider 32 is adjacent the first top flap 26, holding open a space to accept a discharged battery 14. The package 10 may then be displayed for sale.

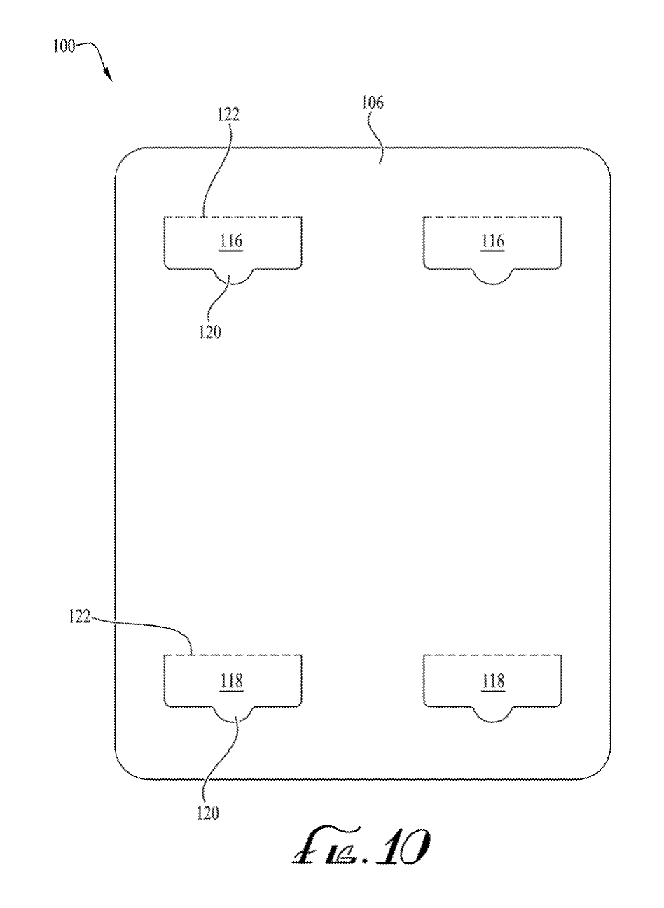

Referring to FIGS. 9-10, an alternative embodiment battery package 100 is shown. The package 100 is a more conventional battery display structure, having one or more preferably clear plastic blisters 102 containing batteries 104, with blisters 102 retained in a preferably cardboard housing 106 as is common in the art. In the illustrated embodiment, a package 100 having two side-by-side blisters 102 is shown, with a fold line or perforation 108 between them, allowing the package 100 to be folded for more convenient storage, or separated according to preference. Like the primary embodiment package 10, the alternative embodiment package 100 includes a divider 110 for separating new and used batteries.

The blisters 102 are preferably elongated and formed to hold individual batteries 104 in series from a top end 112 of each blister 102 to a bottom end 114 of the blister 102. The top end 112 and bottom end 114 correspond to the orientation of the package 100 when held vertically or suspended on display. As shown in FIG. 10, the rear of the housing 106 incorporates a top flap 116 and a bottom flap 118, each proximal to and in communication with the top end 112 and bottom end 114 of their respective blisters 102. Additionally, each of the top flaps 116 and bottom flaps 118 may include a tab 120 for ease of opening.

To use the alternative embodiment package 100 a user selects and purchases, or otherwise obtains an unopened package 100, which may be suspended, and is preferably folded along the perforation 108. By the manufacturer folding along the perforation 108 and securing the package 100 in a folded configuration prior to sale, access to the top flaps 116 and bottom flaps 118 is prevented, thereby helping to prevent tampering and theft of the batteries 104. To obtain a new battery 104, a user unfolds the package 100, if necessary, and opens one of the bottom flaps 118, optionally using the tab 120 on the bottom flap 118 to pull it away from the housing 106. After opening, the bottom flap 118 remains attached to the housing 106, preferably using a living hinge 122 or similar arrangement. Since the housing 106 is preferably cardboard, the top flaps 116 and bottom flaps 118 have a natural tendency to catch on the housing 106 and remain in place when re-closed.

After opening the bottom flap 118, a battery 104 can be extracted from the bottom end 114 of a blister 102. Due to the weight of a typical battery 104, shaking the package 100 is normally sufficient to urge the battery 104 through the bottom flap 118. Alternatively, a user can push in the blister 102 adjacent the bottom flap 118 to drive it out of the housing 106. The battery 104 can then be used as desired. When a battery 104 is dislodged, and the package properly oriented the weight of the remaining batteries causes them to drive the next battery toward the bottom end 114.

When the dispensed battery 104 is discharged and a new (i.e., charged) battery 104 needed, or multiple batteries 104 needed, another battery 104 can be extracted using the same technique. Prior to obtaining a battery 104, an existing spent (i.e., discharged) battery 104 can be stored for recycling by placing it back in the package 100 through the top flap 116. To place a battery 104 in the package 100 for storage, a user opens a top flap 116, optionally using the tab 120 on the top flap 116 to pull it away from the housing 106. Like the bottom flaps 118, the top flaps 116 preferably remain attached to the housing 106 using a living hinge 122 or similar connecting arrangement.

With a top flap 116 open, the user can insert the spent battery 104 into the divider 110, which in one embodiment serves as a housing for the battery 104. Alternatively, the divider 110 may simply provide a space above which the battery 104 can be inserted. In various alternative embodiments, any divider 110 may be used that separates the new (charged) batteries 104 being extracted from the package 100 from used batteries 104 inserted into the package 100. When the package 100 is held upright, the weight of the battery 104 in (or above) the divider 110 causes it to move down inside its respective blister 102. It should be understood that the expressions “top flap 116” and “bottom flap 118” are used interchangeable inasmuch as the invention works the same in a reversed vertical orientation, as long as the divider 110 starts at the ‘top’ of the blister.

Once the last new battery 104 has been withdrawn from the bottom flap 118, used, and placed back into the package 100 (or another used battery placed in the package 100) through the top flap 116, the package 100 now containing all discharged batteries 104 can be easily taken back to the original place of sale, or another location accepting batteries for recycle. In the embodiment illustrated in FIGS. 9 and 10, once both blisters 102 are filled with used batteries 104, as indicated by the dividers 110 reaching a bottom end 114 of a blister 102, the package can be re-folded prior to delivery to a recycling center.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A box for retailing batteries and recycling the batteries after discharge, the box comprising:
a top flap, a first bottom flap, and a plurality of windows substantially spanning the box from proximal the top flap to proximal the first bottom flap;
the plurality of windows sized to reveal the batteries inside the box while preventing the batteries from exiting through the plurality of windows;
a movable divider in the box, the divider configured to cradle one of the batteries, and further configured to obscure one of the plurality of windows; and
the box configured to store the batteries aligned in a column, such that when one of the batteries is removed from the box, the divider moves relative to the box.

2. The box of claim 1 wherein when one of the batteries is removed, the divider moves away from the top flap and toward the first bottom flap.

3. The box of claim 1 further comprising a second bottom flap, the second bottom flap opposing the first bottom flap.

4. The box of claim 3 wherein the first bottom flap and the second bottom flap are configured such that pressing the first bottom flap urges one of the batteries out of the second bottom flap.

5. The box of claim 1 wherein the windows are disposed on a front panel of the box.

6. The box of claim 1 wherein the windows are disposed as a single column along a front panel of the box.

7. The box of claim 1 wherein the divider comprises a u-shaped channel.

8. The box of claim 1 wherein the divider substantially spans a front panel of the box.

9. The box of claim 1 wherein the box comprises a handle portion extending above the batteries for suspending and displaying the box.

10. The box of claim 1 wherein the top flap is disposed adjacent a handle portion extending above the batteries.

11. A box for retailing and recycling batteries, the box comprising:
a box portion and a handle portion extending above the box portion;
the box portion having a top flap adjacent the handle portion, and a first bottom flap and a second bottom flap opposite the handle portion;
a multiplicity of windows disposed on the box portion, the multiplicity of windows configured to display the batteries;
a slidable divider in the box portion, the divider configured to cradle one of the batteries, and further configured to obscure one of the multiplicity of windows; and
wherein when one of the batteries is removed from the box portion, the divider and remaining of the batteries slide down toward the first bottom flap.

12. The box of claim 11, wherein the front panel spans a first side panel and a second side panel, the first side panel and the second side panel each substantially the width of each of the batteries.

13. The box of claim 11 wherein the first bottom flap and the second bottom flap are configured such that pressing the first bottom flap urges one of the batteries out of the second bottom flap.

14. The box of claim 11 wherein the windows are disposed as a single column along the front panel of the box.

15. The box of claim 11 wherein the divider is a u-shaped channel.

16. The box of claim 11 wherein the divider substantially spans the front panel.

17. The box of claim 11 wherein the box portion and the handle portion are formed from a unitary cardboard blank.

18. A package for storing and recycling batteries, the package comprising:
a battery container portion having a bottom flap through which charged batteries are removed for use, a top flap through which discharged batteries are inserted for storage and recycling, and a window through which the charged batteries and discharged batteries may be viewed;
a slidable divider in the battery container portion, the slidable divider configured to cradle one of the discharged batteries, wherein the slidable divider is visible through the window; and
wherein when one of the charged batteries is removed from the battery container portion through the bottom flap, the slidable divider and the discharged batteries slide down toward the bottom flap.
